(19) United States
(12) Patent Application Publication
(10) Pub. No.: US 2014/0288211 A1
(43) Pub. Date: Sep. 25, 2014

(54) Light Diffusing Thermoplastic Resin Compositions And Light Diffusing Members

(71) Applicant: Dow Coming India Private Limited, Mumbai (IN)

(72) Inventors: Vishal Y. Joshi, Gujarat (IL); Srikanth Kamath, Maharashtra (IL); Dharmesh R. Shah, Maharashtra (IL); Milind Vaidya, Maharashtra (IL)

(21) Appl. No.: 14/354,281

(22) PCT Filed: Oct. 12, 2012
(86) PCT No.: PCT/IB2012/002029

§ 371 Date: Apr. 26, 2014

(30) Foreign Application Priority Data
Oct. 31, 2011 (IN) IN 3061/MUM/2011

(51) Int. Cl. C08K 3/36; C08K 9/04

(52) U.S. Cl. CPC C08K 3/36; C08K 9/04
USPC 523/216; 524/493

(57) ABSTRACT

A light diffusing thermoplastic resin composition comprising: (A) a transparent thermoplastic resin; and (B) organic modified functional silica particles having 5 μιη to 15 μιη of the average particle size and 600 m2/g to 800 m2/g of the BET specific surface area, wherein the amount of component (B) is 0.05 to 20% by weight of total amount of components (A) and (B), has an excellent light diffusing property and a high total light transmittance, inhibits discoloration, when melt-processed or used.

### TECHNICAL FIELD

The present invention relates to light diffusing thermoplastic resin compositions, and to light diffusing members molded thereby.

### BACKGROUND ART

Transparent thermoplastic resins transmit light and are used in a broad range of applications in electrical, electronic, OA, automotive and other areas, and resins that deliver the performance demanded in individual applications are selected to suit the applications. When transparent thermoplastic resins are used, particularly in applications such as direct-typed and edge light typed backlight units for liquid crystal display type televisions, lighting device covers, switches in various devices and the like, the light source is visible since the resin transmits light. Therefore, a material having sufficient light diffusing properties such that it does not reveal the shape of the light source (a lamp) behind a molded resin product is being sought.

In the conventional technology, a method in which polymer or inorganic particles with a different index of refraction were added as a dispersed phase to a continuous phase formed using a thermoplastic resin was used for the purpose of imparting light diffusing properties to a transparent thermoplastic resin. In addition, a method to realize desired light diffusion properties by adjusting the refractive index difference between said dispersed phase and the continuous phase or the size of said particles in the dispersed phase has been proposed (see Japanese Unexamined Patent Application Publication Nos. 2006-321987 and 2007-192866).

However, even better light diffusion properties are being sought. Although various improvements associated with the composition of the light diffusing agent, refractivity, particle shapes, particle sizes and the like have been investigated, the optical performance realized is determined by the light diffusion agent added, and circumstances make achieving the level of optical performance demanded by modifying the light diffusion agent difficult. Simultaneously, a reduction in the thickness of light diffusion sheets due to the demand for thinner said units, lower production cost and the like is needed in a light diffusion sheet, particularly in the light diffusion sheet used in direct-typed backlight units for large liquid crystal display type televisions, and a light diffusion sheet with a mechanical strength responsive to the needs is being sought. In addition, light diffusion sheets that display bright colors but also possess a level of thermal stability that inhibits color changes (yellowing) in a thermoplastic resin during mold processing with accompanying poor appearance in molded resin products and exceptional light resistance that inhibits discoloration in molded resin products upon exposure to light sources are being sought when desired.

It is an object of the present invention to provide light diffusing thermoplastic resin compositions that have good light dispersion despite their high rate of light transmission. It is another object of the present invention to provide light diffusing members that have excellent optical properties like higher light transmission rate, better light diffusion characteristics, color stability or light resistance.

### DISCLOSURE OF INVENTION

A light diffusing thermoplastic resin composition of the present invention comprises:

(A) a transparent thermoplastic resin; and
(B) organic modified functional silica particles having 5 μm to 15 μm of the average particle size and 600 m²/g to 800 m²/g of the BET specific surface area, wherein the amount of component (B) is 0.05 to 20% by weight of total of components (A) and (B).

A light diffusing material of the present invention is molded by the light diffusing thermoplastic resin composition.

### EFFECTS OF INVENTION

The light diffusing thermoplastic resin compositions of the present invention have good light dispersion despite their high rate of light transmission. Light diffusing members of the present invention have excellent optical properties like higher light transmission rate, better light diffusion characteristics, color stability or light resistance.

### BRIEF DESCRIPTION OF THE DRAWINGS

FIG. 1(a) is a picture of SEM analysis of a polycarbonate resin composition containing 1 wt % of organic modified functional silica particles.

FIG. 1(b) is a picture of SEM analysis of a polycarbonate resin composition containing 0.5 wt % of organic modified functional silica particles.

FIG. 1(c) is a picture of SEM analysis of a polycarbonate resin composition containing 0.2 wt % of organic modified functional silica particles.

FIG. 1(d) is a picture of SEM analysis of a polycarbonate resin composition containing 0.1 wt % of organic modified functional silica particles.

FIG. 2(a) is EDX chart showing carbon, oxygen and silicon distributed in polycarbonate resin containing 0.1 wt % of organic modified functional silica particles.

FIG. 2(b) is EDX chart showing carbon, oxygen and silicon distributed in polycarbonate resin containing 0.2 wt % of organic modified functional silica particles.

### DETAILED DESCRIPTION OF THE INVENTION

Component (A) is a transparent thermoplastic resin, and is exemplified by polycarbonate resins; poly(methyl methacrylate); polystyrene; and styrene type copolymers such as acrylonitrile-styrene copolymers, methyl methacrylate-styrene copolymers, acrylonitrile-butadiene-styrene copolymers and the like; polyesters, poly(ether imides); polyimides; polyamides; modified poly(phenylene ether); polyarylates; cycloolefin polymers; polymer alloys obtained by blending polycarbonates with polyesters and the like. Polycarbonate resins, poly(methyl methacrylate), polyarylates, styrene type copolymer resins and cycloolefin polymers are preferable.

The polycarbonate resin used in the present invention is a polymer that can be obtained using a phosgene method wherein various dihydroxy diaryl compounds and phosgene are allowed to react or using a transesterification method wherein a dihydroxy diaryl compound and a carbonate ester such as diphenyl carbonate and the like are allowed to react. As a typical example, polycarbonate resins produced using 2,2-bis(4-hydroxyphenyl) propane (bisphenol A) can be cited.

As the dihydroxy diaryl compound described above, bis(hydroxyaryl) alkanes such as bis(4-hydroxyphenyl) methane, 1,1-bis(4-hydroxyphenyl) ethane, 2,2-bis(4-hydroxyphenyl) butane, 2,2-bis(4-hydroxyphenyl) octane, bis(4-hydroxyphenyl) phenyl methane, 2,2-bis(4-hydroxyphenyl-3-methylphenyl) propane, 1,1-bis(4-hydroxy-3-bromophenyl) propane, 2,2-bis(4-hydroxy-3,5-dibromophenyl) propane and 2,2-bis(4-hydroxy-3,5-dichlorophenyl) propane; bis(hydroxyaryl) cycloalkanes such as 1,1-bis(4-hydroxyphenyl) cyclopentane and 1,1-bis(4-hydroxyphenyl) cyclohexane; dihydroxy diaryl ethers such as 4,4′-dihydroxy diphenyl ether and 4,4′-dihydroxy-3,3′-dimethyldiphenyl ether; dihydroxy diaryl sulfides such as 4,4′-dihydroxy diphenyl sulfide; dihydroxy diaryl sulfoxides such as 4,4′-dihydroxy diphenyl sulfoxide and 4,4′-dihydroxy-3,3′-dimethyl diphenyl sulfoxide and dihydroxy diaryl sulfones such as 4,4′-dihydroxy diphenyl sulfone and 4,4′-dihydroxy-3,3′-dimethyl diphenyl sulfone and the like may be cited in addition to bisphenol A. They may be used individually or as a mixture of at least two types. In addition to these examples, piperazine, bipiperidyl hydroquinone, resorcinol, 4,4′-dihydroxydiphenyl and the like may ne mixed and used.

Furthermore, the dihydroxy diaryl compounds described above and phenol compounds with at least three valences such as those shown below may be mixed and used. As the phenol with at least three valences, fluoroglucine, 4,6-dimethyl-2,4,6-tri(4-hydroxyphenyl) heptene, 2,4,6-trimethyl-2,4,6-tri(4-hydroxyphenyl) heptane, 1,3,5-tri(4-hydroxyphenyl) benzol, 1,1,1-tri(4-hydroxyphenyl) ethane and 2,2-bis[4,4-(4,4′-dihydroxydiphenyl) cyclohexyl]propane and the like may be cited.

The average molecular weight of the polycarbonate resin is ordinarily 10,000 to 100,000, prefeably 15,000 to 35,000, and most preferably 17,000 to 28,000. When producing such a polycarbonate resin, a molecular weight adjusting agent, a catalyst and the like may be used as needed.

Component (B) is organic modified functional silica particles, and has 5 μm to 15 μm of the average particle size and 600 m²/g to 800 m²/g of the BET specific surface area. Component (B) may be high porosity silica particles which have greater than 90% of porosity. Component (B) has on its surface organic functional group such as trimethylsilyl, triethylsilyl, dimethylvinylsilyl, dimethyiphenylsilyl. As the result, component (B) is completely hydrophobic.

A method for manufacturing of the organic modified functional silica particles is not limited. For example, U.S. Pat. No. 7,470,725 describes a method comprising the following steps:

a) modifying the surface of the silica aerogels by silylation agent; and
b) drying the surface-modified gel obtained in step a).

The silylating agent can in principle be in any aggregate state but is preferably in liquid form and/or is a gas or vapor. If the silylating agent is used as a gas and/or vapor the temperature of the aqueous silica aerogels is preferably between 20 and 100 □, with particular preference between 40 and 100 □, and, in particular, between 60 and 100 □. Under pressure, higher temperatures are also possible in order to avoid boiling of the water in the gel capillaries. If the silylating agent is used as a liquid the temperature of the aqueous silica aerogels is preferably between 20 and 100 □. Under pressure, higher temperatures are also possible in order to avoid boiling of the water in the gel capillaries. If the silylating agent is used as a gas and/or vapor it may be present during the reaction in a gas stream or in a static gas atmosphere. The temperature of the silylating agent or agents in the gas phase can also be increased by means of pressure or by an additional gas stream.

In a preferred embodiment, the silylating agent can also be introduced in liquid phase. In this case it can be employed directly as liquid phase and/or may form on the surface of the hydrogel as a result of the condensation of a gas employed. The temperature of the liquid phase can then be between 0 □ and the boiling point of the silylating agent/agents. Preference is given to temperatures between 20 and 100 □. If desired, it is also possible to operate under pressure with higher temperatures. In general, surface silylation takes place faster at higher temperatures.

In accordance with a preferred embodiment, disiloxanes of the formula I and/or disilazanes of the formula II are employed as silylating agents.

R₃Si—O—SiR₃ (I)

R₃Si—N(H)—SiR₃ (II)

In the formulae, R are identical or different and are each a nonreactive, organic, linear, branched, cyclic, saturated or unsaturated, aromatic or heteroaromatic radical, preferably C₁-C₁₈ alkyl or C₆-C₁₄ aryl, particularly preferably C₁-C₆ alkyl, cyclohexyl or phenyl, especially methyl or ethyl. Preferably the silica aerogels in step a) is reacted with a symmetrical disiloxane that is, one in which both Si atoms have the same R. It is particularly preferred to employ disiloxanes in which all R are identical. In particular, hexamethyldisiloxane is used.

It is possible, furthermore, to employ all silylating agents known to the skilled worker which are immiscible with water. If the silylating agents are largely or wholly insoluble in water, as is the case for hexamethyldisiloxane (HMDSO), for example, then they are easy to separate from the aqueous phase which forms as a result of the water in and from the gel. This permits easy recycling of excess reagents. By this means it is possible, for example, to minimize the silylation times by using excess concentrations.

The silylating agents necessary for the actual silylation reaction can also be generated from other substances, preferably other silylating agents. This can be done shortly before and/or during the silylation. Furthermore, it can also be done not until directly before and/or during the reaction on the internal surface of the silica aerogels. In this context the term silylating agents also includes a mixture of substances which are necessary for the actual silylation or which are in principle in chemical equilibrium with one another. The mixture may, for example, include a base or acid which acts as catalyst.

Surface silylation in step a) takes place in the presence of at least one silylating agent and, if desired, at least one acid or one base already present in the silica aerogels, preference being given here again to the abovementioned acids and bases.

Such organic modified functional silica particles are commercially available as “Dow Corning® VM-2270 Aerogel Fine Particles” from Dow Coming Corporation.

The amount of component (B) is 0.05 to 20% by weight of total amount of components (A) and (B). When the amount is less than 0.05% by weight, a sufficient light diffusing effect is difficult to attain and sufficient mechanical strength cannot be obtained, making this option unfavorable. Similarly, when the amount exceeds 20% by weight, the light transmittance is adversely affected and sufficient light diffusing performance cannot be achieved, making this option unfavorable. The range from 0.1 to 10% by weight, especially, 0.1 to 5% by weight is more preferred□

In addition, a variety of well known antioxidants may be added when stability is needed. As to the variety of antioxidants, phosphite type antioxidants, phosphate type antioxidants, phosphonite type antioxidants and ester type antioxidants thereof may be cited. Of the antioxidants, cyclic phosphite ester type compounds prepared by allowing phenols or bisphenols, phosphorus trihalides and amine compound to react are particularly preferred.

The amount of the antioxidant may be 1 part by weight or less per 100 parts by weight of components (A) and (B). When the amount exceeds 1 part by weight, resin degradation is accelerated and sufficient mechanical strength cannot be obtained, making this option unfavorable. The range of from 0.05 parts by weight to 0.6 parts by weight is preferred.

In addition, a variety of well known ultraviolet light absorbers may be added when stability is needed. As to the variety of ultraviolet light absorbers, benzophenone type ultraviolet light absorbers, benzotriazole type ultraviolet light absorbers, triazine type ultraviolet light absorbers, malonic acid ester type ultraviolet light absorbers and oxalanilide type ultraviolet light absorbers may be cited. These ultraviolet light absorbers may be used individually or in a combination of at least two. Of the ultraviolet light absorbers, those with a structure containing alkyl groups and alkoxy groups symmetrically substituted on the two nitrogen atoms in the oxanilide framework, which is represented by a chemical formula below, are ideally used. N-(2-Ethylphenyl)-N′-(2-ethoxyphenyl) oxalic acid diamide is exceptionally ideal.

The amount of the ultraviolet light absorber may be from 0.01 parts by weight to 0.8 parts by weight per 100 parts by weight of components (A) and (B). When the amount is less than 0.01 parts by weight, sufficient light resistance is not obtained, making this option unfavorable. Similarly, when the amount added exceeds 0.8 parts by weight, thermal stability declines, making this option unfavorable. The range from 0.05 parts by weight to 0.6 parts by weight is more preferred.

In addition, a variety of well known flame retardants may be added when flame retardance is needed. As to the variety of flame retardants, bromine type flame retardants such as tetrabromobisphenol A oligomers and the like; monophosphate esters such as triphenyl phosphate, tricresyl phosphate and the like; oligomer type condensed phosphate esters such as bisphenol A diphosphate, resorcinol diphosphate, tetraxylenyl resorcinol diphosphate and the like; phosphorus type flame retardants such as ammonium polyphosphate, red phosphorus and the like; various silicone type flame retardants and aromatic sulfonic acid metal salts and perfluoroalkane sulfonic acid metal salts used to enhance flame retardance, for example, may be cited. Ideally, organic metal salts such as 4-methyl-N-(4-methylphenyl) sulfonylbenzene sulfonamide potassium salt, potassium diphenylsulfone-3-sulfonate, sodium para-toluenesulfonate, potassium perfluorobutane sulfonate and the like may also be added.

In addition to the well known additives listed above, lubricants (paraffin wax, n-butyl stearate, synthetic beeswax, natural beeswax, glycerin monoesters, montan acid wax, polyethylene wax, pentaerythritol tetrastearate and the like), coloring agents (titanium oxide, carbon black and dyes, for example), fillers (calcium carbonate, clay, silica, glass fibers, glass spheres, glass flakes, carbon fibers, talc, mica, various whiskers and the like), flow modifiers, developing agents (epoxidized soy bean oil, fluid paraffin and the like), other thermoplastic resins and various impact modifiers (rubber reinforced resins obtained by graft polymerization of compounds such as methacrylate esters, styrene, acrylonitrile and the like on a rubber such as polybutadiene type rubber, poly(acrylate ester) rubber, ethylene-propylene type rubber and the like can be listed as examples), for example, may be added as needed to the light diffusing thermoplastic resin composition of the present invention.

The order in which the present invention is executed is not restricted at all. For example, a method in which components (A) and (B) as well as an antioxidant, an ultraviolet light absorber, or a flame returdant are measured in optional amounts, mixed using any of a tumbler, ribbon blender, high speed mixer and the like and the mixture is subsequently melted and compounded using an ordinary single or twin screw extruder to form pellets; a method in which a portion or all of the individual components are separately measured, added to an extruder from multiple numbers of supply devices and melted and kneaded; and, furthermore, a method in which high concentrations of component (A) and an antioxidant, an ultraviolet light absorber, or a flame returdant are added, melted and mixed once to form pellets of a master batch and said master batch obtained is subsequently mixed in a desired proportion with component (B) may be used. When melting and mixing these components, the conditions such as the addition locations in the extruder, extrusion temperature, screw rotation rate, amount supplied and the like are optionally selected according to the circumstances for the pellet formation. Furthermore, said master batch and component (B) may be mixed dry according to a desired proportion and subsequently added directly to an injection molding machine or a sheet extrusion machine to obtain molded products. In addition, the method with which the light diffusing thermoplastic resin composition of the present invention is molded is not particularly restricted, and well known injection molding methods, injection compression molding methods, extrusion molding methods and the like may be used.

The light diffusion thermoplastic resin composition of the present invention can carry out forming method application of the common thermoplastics, for example, injection moulding from a pellet type resin composite, injection compression molding, and extrusion molding are possible for it from a point of productivity. It can also be considered as the target Plastic solid by the vacuum forming from the sheet-shaped mold goods by which extrusion molding was furthermore carried out, pressure forming, etc.

As a light diffusing materials of the present invention is molded by the light diffusion themoplastic resin composition, the light guide plate of a liquid crystal display, a diffusion board, a light reflector, a protective film, a phase difference film and an illuminating cover, the screen of a transmission type, various displays, etc. are mentioned, and it can use conveniently as an optical member for liquid crystal displays especially.

### EXAMPLES

The light diffusing thermoplastic resin composition and light diffusing member of the present invention will be further described in more detail with reference to Practical and Comparative examples.

### Practical Examples 1 to 4 and Comparative Example 1

99.90 (Practical Example 1), 99.80 (Practical Example 2), 99.50 (Practical Example 3) and 99 (Practical Example 4) weight parts of polycarbonate resin flaks (made by Reliance Industries, India having Refractive Index of 1.58) were first preheated at 110 □ in preheated oven for 30 min. to remove moisture and then combined with 0.1, 0.2, 0.5 and 1 respective weight part of trimethylsilyl modified functional silica perticles (“Dow Corning® VM-2270 Aerogel Fine Particles” from Dow Corning Corporation; average particle size ranges from 5-15 microns; Bulk Density ranges from 40-100 kg/m³; BET specific surface area ranges from 600-800 m²/g; and porosity is around >90%) in hopper of injection molding machine. The mixture was fed to a 150-t Injection molding machine to form specimens having dimension of 7 cm (length)×2.5cm (width)×0.3cm (breath). Total of 4 specimens of the different compositions, were developed which were then tested to measure their optical properties. The molding temperature for specimens was range from 240 □ to 270 □.

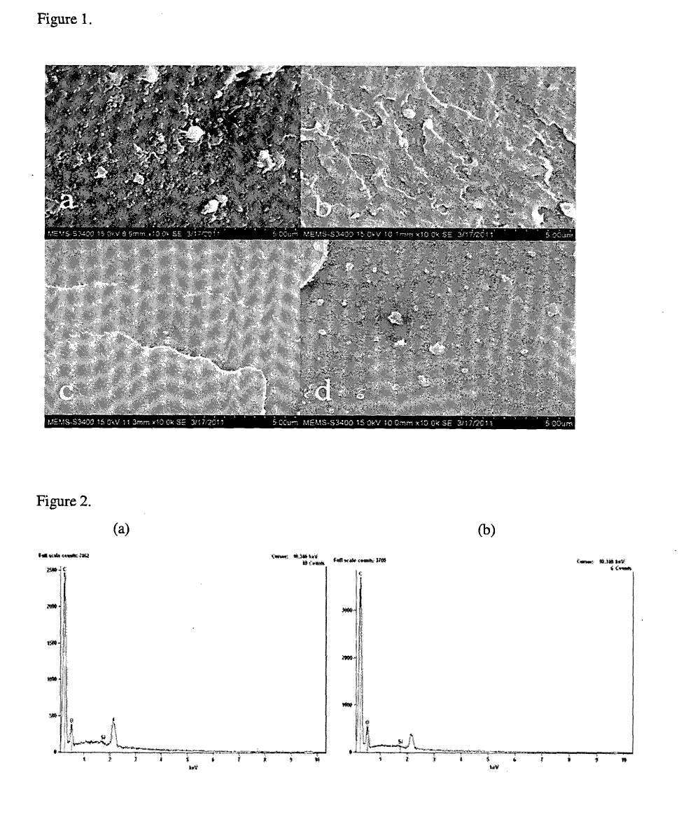

Analytical characterizations like Cryo SEM (scanning electron microscopy) and EDX (energy dispersed x-ray) were taken for each specimen. Characterizations of the specimens with their optical properties along with analytical study are listed in Table 1. Pictures of Cryo SEM analyses of various specimens are shown in FIG. 1 (a) to (d). EDX analysis and silicone distribution in the polycarbonate matrix is shown in FIG. 2. These clearly indicate that silicone is uniformly distributed in polycarbonate matrix. Photometric characterization was conduct using C-gamma type photo-goniometer (for rotational and planner symmetry). From the polar curve (perpendicular rotation (90) and side wise rotation (o)) were recorded for 0 to 180 and main data are shown in Table 1. During photometric study, readings were recorded at Current input 0.034A; Wattage input 4.1W and Voltage input DC 12V. This are taken from IS references IS: 10322(PART4)-1984 IS: 10322(PART5/SEC3)-1987 IS: 10322(PART5/SEC4)-1987 IS: 10322(PART4/SEC5)-1987. As can be seen from Table 1, the small amount of additive used in Practical Example 1, was sufficient to give a composition whose light-diffusing characteristics surpassed those obtained in the comparison, while its other properties remained comparable or even improved. This effect was also seen in Practical Examples 2, 3 and 4. In Practical Examples 3 and 4 there was less of an effect in terms of total lumen output, but the other properties were excellent, so in certain applications it may be appropriate to use an amount of additive in this range.

TABLE 1

| | Practical | Practical | Practical | Practical | Comparison |
|---|---|---|---|---|---|
| | Example 1 | Example 2 | Example 3 | Example 4 | Example 1 |
| Polycarbonate Resin (wt. %) | 99.90 | 99.80 | 99.50 | 99.00 | 100 |
| Silica silylate (wt. %) | 0.10 | 0.20 | 0.50 | 1.0 | 0 |

EDX characterization (% Atom)

| | | | | | |
|---|---|---|---|---|---|
| Carbon K line | 88.42 | 84.97 | 88.07 | 83.29 | — |
| Oxygen K line | 11.37 | 14.56 | 10.81 | 15.61 | — |
| Silicone K line | 0.21 | 0.47 | 0.52 | 1.11 | — |

Optical Characteristics

| Relative Lumaire efficiency (%) | 80 | | 90 | | 65 | | 70 | | 100 | |
|---|---|---|---|---|---|---|---|---|---|---|
| Perpendicular to panel | | | | | | | | | | |
| Relative Lumaire efficiency (%) | 7 | | 20 | | 30 | | 50 | | 20 | |
| Along the panel | | | | | | | | | | |
| Luminaire efficacy (lm/w) | 317 | (0^{θ}) | 269 | (0^{θ}) | 69 | (0^{θ}) | 37 | (0^{θ}) | 349 | (0^{θ}) |
| Perpendicular to panel | 388 | (5^{θ}) | 298 | (5^{θ}) | 83.2 | (5^{θ}) | 36.8 | (5^{θ}) | 425 | (5^{θ}) |
| | 278 | (10^{θ}) | 251 | (10^{θ}) | 76 | (10^{θ}) | 36.8 | (10^{θ}) | 422 | (10^{θ}) |
| Luminaire efficacy (lm/w) Along | 317 | (0^{θ}) | 269 | (0^{θ}) | 69 | (0^{θ}) | 36.8 | (0^{θ}) | 349 | (0^{θ}) |
| the panel | 164 | (5^{θ}) | 164 | (5^{θ}) | 49 | (5^{θ}) | 36.8 | (5^{θ}) | 253 | (5^{θ}) |
| | 56 | (10^{θ}) | 79 | (10^{θ}) | 37 | (10^{θ}) | 35.4 | (10^{θ}) | 90 | (10^{θ}) |

| Transmission Rate (Brightness in | 1600 | 1200 | 380 | 180 | >1800 |
|---|---|---|---|---|---|
| Lumen) for Perpendicular to | | | | | |
| panel | | | | | |
| Transmission Rate (Brightness in | 1320 | 1100 | 300 | 170 | 1400 |
| Lumen) for Along the panel | | | | | |
| Diffusion Characteristics | 0 to 17 | 0 to 20 | 0 to 25 | 0 to 30 | No |
| | degree | degree | degree | degree | |
| Color Stability/Light resistance | Yes | | | | No |
| Center Beam Candle Power | 1591 | 1223 | 341 | 151 | 1760 |
| (CBCP) for Perpendicular to | | | | | |
| panel | | | | | |
| Center Beam Candle Power | 1301 | 1102 | 283 | 151 | 1430 |
| (CBCP) for Along the panel | | | | | |
| Beam Angle for Perpendicular to | 24 | 24 | 22 | 60 | 20 |
| panel | | | | | |
| Beam Angle for Along the panel | 10 | 10 | 29 | 40 | 14 |

### INDUSTRIAL APPLICABILITY

The light diffusing thermoplastic resin compositions of the present invention have good light dispersion despite their high rate of light transmission. As a result they are penetrated readily by light beams even though the shape of the light source is not visible. Moreover organic modified functional silica particles have high thermal and light stability, lower specific gravity, excellent chemical resistance, water repellency, good compatibility with matrix resin and low moisture adsorption. It is also fit for thinner panel development as addition rate of diffuser to resin matrix is extremely low. Light diffusing members of the present invention have excellent optical properties like higher light transmission rate, better light diffusion characteristics, color stability or light resistance. They can therefore be used to advantage in applications where excellent and uniform diffusion of Si in thermoplastic resin are recommended composites panels for use in different lighting application such as environmental lighting, home lighting and street lighting applications.

1. A light diffusing thermoplastic resin composition comprising:
(A) a transparent thermoplastic resin; and
(B) organic modified functional silica particles having an average particle size of 5 μm to 15 μm and a BET specific surface area of 600 m²/g to 800 m²/g of the BET specific surface area;
wherein the amount of component (B) is 0.05% to 20% by weight of the total amount of components (A) and (B).

2. The light diffusing thermoplastic resin composition of claim 1, wherein component (A) is at least one thermoplastic resin selected from the group consisting of polycarbonate resins, poly(methyl methacrylate), polyarylates, polystyrenes, styrene type copolymers and cycloolefin polymers.

3. The light diffusing thermoplastic resin composition of claim 1, wherein component (B) has triorganosilyl radicals on its surface.

4. The light diffusing thermoplastic resin composition of claim 1, wherein the amount of component (B) is 0.1% to 10% by weight of the total amount of components (A) and (B).

5. A light diffusing material molded by the light diffusing thermoplastic resin composition of claim 1.

6. The light diffusing material of claim 5, having the form of a sheet.

7. The light diffusing thermoplastic resin composition of claim 2, wherein component (A) is a polycarbonate resin.

8. The light diffusing thermoplastic resin composition of claim 7, wherein the polycarbonate resin has an average molecular weight of 10,000 to 100,000, alternatively 15,000 to 35,000.

9. The light diffusing thermoplastic resin composition of claim 4, wherein the amount of component (B) is 0.1% to 5% by weight of the total amount of components (A) and (B).

10. The light diffusing thermoplastic resin composition of claim 1, wherein component (B) has:
i) greater than 90% porosity;
ii) a bulk density ranging from 40 to 100 kg/m³; or
iii) both i) and ii).

11. The light diffusing thermoplastic resin composition of claim 3, wherein component (B) has an organic functional group on its surface selected from trimethylsilyl, triethylsilyl, dimethylvinylsilyl, and dimethylphenylsilyl.

12. A light diffusing thermoplastic resin composition comprising:
(A) a transparent thermoplastic resin comprising a polycarbonate resin; and
(B) organic modified functional silica particles having an average particle size of 5 μm to 15 μm and a BET specific surface area of 600 m²/g to 800 m²/g;
wherein the amount of component (B) is 0.05% to 20% by weight of the total amount of components (A) and (B); and
wherein component (B) has triorganosilyl radicals on its surface.

13. The light diffusing thermoplastic resin composition of claim 12, wherein component (B) has an organic functional group on its surface selected from trimethylsilyl, triethylsilyl, dimethylvinylsilyl, and dimethylphenylsilyl.

14. The light diffusing thermoplastic resin composition of claim 12, wherein the amount of component (B) is 0.1% to 10% by weight, alternatively 0.1% to 5% by weight, of the total amount of components (A) and (B).

15. A light diffusing material molded by the light diffusing thermoplastic resin composition of claim 12.

16. The light diffusing material of claim 15, having the form of a sheet.
